(19) United States
(12) Patent Application Publication
(10) Pub. No.: US 2023/0405950 A1
(43) Pub. Date: Dec. 21, 2023

(54) PROCESS FOR PRODUCING NON-PNEUMATIC TIRES

(71) Applicant: The Goodyear Tire & Rubber Company, Akron, OH (US)

(72) Inventors: Claude Ernest Félix Boes, Erpeldange-sur-Sûre (LU); Francesco Sportelli, Bettembourg (LU)

(21) Appl. No.: 17/807,776

(22) Filed: Jun. 20, 2022

(51) Int. Cl. B29D 30/02; B29C 64/209

(52) U.S. Cl. CPC B29D 30/02; B29C 64/209; B33Y 10/00

(57) ABSTRACT

The invention is directed to a process for the production of at least a part of a non-pneumatic tire structure, the non-pneumatic tire structure comprising an inner band, an outer band surrounding the inner band and a spoke part comprising a plurality of spokes extending between the inner band and the outer band; wherein the process comprises providing a first plastic composition in the form of a filament comprising a continuous fiber coated with a first thermoplastic resin; and forming one or more selected from one or more spokes of the plurality of spokes, the inner band and the outer band of the non-pneumatic tire structure by 3D printing, wherein forming includes depositing layers of the first plastic composition.

### FIELD OF THE INVENTION

The invention relates to a process for producing tires, such as non-pneumatic tires, and in particular to a process for the production of at least a part of a non-pneumatic tire structure by additive manufacturing using continuous fibers.

### BACKGROUND OF THE INVENTION

Pneumatic tires are efficient at carrying loads because the whole tire structure is involved in carrying the load. Pneumatic tires are also desirable because they have low contact pressure, resulting in lower wear on roads due to the distribution of the load of the vehicle. Pneumatic tires have also low stiffness, which ensures a comfortable ride in a vehicle. The primary drawback of a pneumatic tire is that it requires compressed gas. A conventional pneumatic tire is rendered useless after a complete loss of inflation pressure or has at least an increased rolling resistance at low inflation pressures.

A tire designed to operate without inflation pressure may eliminate many of the problems and compromises associated with a pneumatic tire. Neither pressure maintenance nor pressure monitoring is required. In a non-pneumatic tire, spokes are often provided between a tread and a wheel similar to the function of the air pressure of the conventional pneumatic tire. The structure and the shape of the spokes are important factors that determine the driving performance and/or rolling resistance of the non-pneumatic tire.

U.S. Pat. No. 10,538,130 describes a non-pneumatic tire with a band part which includes an inner band and an outer band that is separated from the inner band and surrounds an outer peripheral surface of the inner band and a spoke part extending in a circumferential direction between the inner band and the outer band, having a circumferential cross-section having one or more holes, wherein the spoke part further comprises a first spoke and a second spoke of special shapes. The inner band, the outer band, the first spokes, and the second spokes may form a single continuous member. The single continuous member may be manufactured by using a 3D printer.

### SUMMARY OF THE INVENTION

One or more of the above needs can be fulfilled by the present invention wherein a non-pneumatic tire structure or at least a part of a non-pneumatic tire structure such as one or more spokes is produced by additive manufacturing using one or more 3D-printers and at least one plastic composition comprising a continuous fibercoated with a thermoplastic resin.

According to a first aspect, the invention is directed to a process for the production of at least a part of a non-pneumatic tire structure, the non-pneumatic tire structure comprising an inner band, an outer band surrounding the inner band and a spoke part comprising a plurality of spokes extending between the inner band and the outer band, wherein the process further comprises the steps of:
providing a first plastic composition in the form of a filament comprising a continuous fiber coated with a first thermoplastic resin; and
forming one or more selected from at least one spoke of (one or more spokes of) the plurality of spokes, the inner band and the outer band of the non-pneumatic tire structure by 3D printing, wherein forming includes depositing layers of the first plastic composition.

For example, the invention provides a production process of at least a part of a non-pneumatic tire structure, the non-pneumatic tire structure comprising one or more of:
an axial direction,
an angular section,
a radial section,
an inner band,
an outer band surrounding the inner band and
a spoke part comprising a plurality of spokes projecting from the inner band to the outer band of a non-pneumatic tire structure,
wherein the process comprises the steps of:
providing a first plastic composition, preferably in the form of a filament comprising a continuous fiber, more preferably coated with a first thermoplastic resin,
providing a second plastic composition, optionally selected from an unreinforced plastic, a short-fiber reinforced thermoplastic resin, a long-fiber reinforced thermoplastic resin, or a fiber reinforced thermoplastic resin, and
forming the branched spoke by 3D printing including depositing layers,
wherein each of said layers comprises a first portion of the first plastic composition and one or more second portions of the second plastic composition,
wherein at least one of the radial section and the angular section exhibits an axial alternation of the first layer portions and second layer portions.

According to a second aspect, the invention is directed to a process for the production of a branched spoke of a non-pneumatic tire structure, wherein the branched spoke is intended to be placed between an inner band and an outer band, wherein the branched spoke has a branched shape with a knot section and a plurality of webs. At least one web of the plurality of webs extends from said knot section towards the inner band, and at least two webs of the plurality of webs extend from said knot section towards the outer band, wherein the process comprises the steps of:
providing a first plastic composition in the form of a filament comprising a continuous fiber coated with a first thermoplastic resin,
providing a second plastic composition selected from an unreinforced plastic, a short-fibers reinforced thermoplastic resin, a long-fibers reinforced thermoplastic resin, or a fiber reinforced thermoplastic resin, and
forming the branched spoke of the non-pneumatic tire structure by 3D printing, including depositing layers of the plastic composition, wherein forming forming the branched spoke of the non-pneumatic tire includes depositing layers from the first plastic composition defining bypassed areas and, for each layer, filling the bypassed areas by depositing the second plastic composition in the bypassed areas, and wherein the bypassed areas comprising the second plastic composition are located at least on one web so that at least one web of the plurality of webs exhibits an alternation of layers of the first plastic composition and the second plastic composition.

For example, the invention provides for a production process of a branched spoke of a non-pneumatic tire structure, wherein the branched spoke is intended to be placed between an inner band and an outer band, wherein the branched spoke comprises:
a branched shape, said branched shape having one or more of:
   an axial direction,
   a knot section, and
   a plurality of webs,
at least one web of the plurality of webs extending from said knot section towards the inner band, and at least two webs of the plurality of webs extending from said knot section towards the outer band;
wherein the process further comprises:
providing a first plastic composition, preferably in the form of a filament comprising a continuous fiber, more preferably coated with a first thermoplastic resin,
providing a second plastic composition optionally selected from an unreinforced plastic, a short-fiber reinforced thermoplastic resin, a long-fiber reinforced thermoplastic resin, or a fiber reinforced thermoplastic resin, and
forming the branched spoke by 3D printing including depositing layers,
wherein each of said layers comprises a first layer portion of the first plastic composition and a second layer portion of the second plastic composition, and
wherein the first layer portions and the second layer portions axially alternate in at least one web.

According to a third aspect, the invention is directed to a process for the production of at least a part of a non-pneumatic tire structure, the non-pneumatic tire structure comprising an inner band, an outer band surrounding the inner band, and a spoke part comprising a plurality of spokes extending between the inner band and the outer band, wherein the process comprises the step of:
providing a 3-D printer, optionally with a heated nozzle;
providing a continuous fiber;
providing a first thermoplastic resin;
coating the continuous fiber with the first thermoplastic material in the (optionally heated) nozzle of the 3-D printer to produce a first plastic composition in the form of a filament comprising the continuous fiber coated with the first thermoplastic resin; and
forming one or more selected from one or more spokes of the plurality of spokes, the inner band and the outer band of the non-pneumatic tire structure by 3D printing, wherein forming includes depositing layers of the first plastic composition.

The following can be used to further define the process according to the first aspect, the second aspect, or the third aspect:

In an embodiment, at least a part of a non-pneumatic tire structure is one or more spokes.

In another embodiment, at least a part of a non-pneumatic tire structure is one or more spokes and the inner band, with preference, the inner band being a hub. In another embodiment, at least a part of a non-pneumatic tire structure is one or more spokes and the outer band, with preference, the inner band being a shear band. In a further embodiment, at least a part of a non-pneumatic tire structure is one or more spokes, the inner band and the outer band. For example, the process is a process for the production of a non-pneumatic tire structure (in particular, the whole non-pneumatic tire structure).

In an embodiment, one or more layers of the first plastic composition extend from at least one spoke of the plurality of spokes to the inner band and/or the outer band, or from the inner band to at least one spoke of the plurality of spokes and the outer band, or within two different spokes of the plurality of spokes.

In an embodiment, the thermoplastic resin of the first plastic composition comprises a polymer selected from the group comprising polyoxymethylene, acrylonitrile butadiene styrene, polyamide, polyether ether ketone, cellulose acetate, cellulose acetate propionate, polylactic acid, polyethylene terephthalate, polyethylene terephthalate glycol, polymethylmethacrylate, polypropylene, polystyrene, polyvinyl chloride, polychloroethene, polyester resin, polycarbonate, thermoplastic polyurethane, polyether sulfone, poly(vinyl alcohol), polyphenyl sulfone, polyetherimide, polyethylene, or combinations thereof.

If present, the thermoplastic resin of the second plastic composition can be of the same nature or type as the thermoplastic resin of the first plastic composition. So, for example, the thermoplastic resin of the first plastic composition and the second plastic composition comprises the same polymer, wherein the polymer is selected from the group comprising polyoxymethylene, acrylonitrile butadiene styrene, polyamide, polyether ether ketone, cellulose acetate, cellulose acetate propionate, polylactic acid, polyethylene terephthalate, polyethylene terephthalate glycol, polymethylmethacrylate, polypropylene, polystyrene, polyvinyl chloride, polychloroethene, polyester resin, polycarbonate, thermoplastic polyurethane, polyether sulfone, poly(vinyl alcohol), polyphenyl sulfone, polyetherimide, polyethylene, or combinations thereof.

For example, the continuous fiber of the first plastic composition is selected from one or more glass fibers, one or more metallic fibers, one or more carbon fibers, one or more thermoplastic polymers fibers having a melting point above 300° C. according to ISO 3146:2000, or combinations thereof; wherein the one or more thermoplastic polymers fibers having a melting point above 300° C. according to ISO 3146:2000, if any, have a melting point according to ISO 3146:2000 that is higher than the melting point of the first thermoplastic resin by at least 20° C.

For example, the continuous fiber of the first plastic composition is selected from one or more cords, one or more yarns, one or more single filaments, or combinations thereof.

For example, the first thermoplastic resin is selected from polyether ether ketone, polysulfone, polyether sulfone, polyether imide, polyamide, polybutylene terephthalate, polyethylene, polycarbonate, thermoplastic polyurethane, or combinations thereof; and/or the continuous fiber has a diameter ranging from 5 to 10 μm and is optionally selected from a carbon fiber or a glass yarn.

For example, the first thermoplastic resin of the first plastic composition is made of or comprises polyamide, thermoplastic polyurethane, or combinations thereof; and/or the continuous fiber of the first plastic composition has a diameter ranging from 5 to 10 μm and is optionally selected from a carbon fiber or a glass yarn.

For example, the second plastic composition is an unreinforced plastic, the first thermoplastic resin and the second thermoplastic resins are the same and are selected from polyether ether ketone, polysulfone, polyether sulfone, polyether imide, polyamide, polybutylene terephthalate, polyethylene, polycarbonate, thermoplastic polyurethane, or combinations thereof; and the continuous fiber is selected from a glass yarn or a carbon fiber.

In an embodiment, forming a plurality of spokes comprises defining a bypassed area in the layer of the first plastic composition and further comprises
providing a second plastic composition selected from an unreinforced plastic, a short-fibers reinforced thermoplastic resin, a long-fibers reinforced thermoplastic resin, or a fibers reinforced thermoplastic resin, and
filling the bypassed area by depositing the second plastic composition in said bypassed area.

In an embodiment, in which one or more spokes of the plurality of spokes have a branched shape, said branched shape has a knot section and a plurality of webs, the plurality of webs comprising at least one inner web extending from said knot section towards the inner band, and at least two outer webs extending from said knot section towards the outer band. The areas bypassed by the first plastic composition and filled by the second plastic composition are located at least on one web so that at least one web of the plurality of webs has alternating layers of the first plastic composition and the second plastic composition.

For example, one or more spokes of the plurality of spokes have a branched shape; said branched shape has a knot section and a plurality of webs, the plurality of webs comprising at least one inner web extending from said knot section towards the inner band, and at least two outer webs extending from said knot section towards the outer band. The layers comprise a first layer and a second layer stacked on the first layer, wherein the bypassed area is located at least at the inner web in the first layer, and the bypassed area is located at least at the outer web in the outer layer, and at least one web of the plurality of webs has alternating layers of the first plastic composition and the second plastic composition.

Preferably, one or more spokes of the plurality of spokes have a branched shape. Said branched shape has a knot section and a plurality of webs extending from the knot section. Within at least one or each of the webs, the layers exhibit an alternation of the first plastic composition and the second plastic composition.

For example, the process further comprises interrupting the deposit of the second plastic composition at the knot section so that the knot section is formed from layers of the first plastic composition which are touching one another, and/or so that the knot section exhibits an axial continuity of the first plastic composition.

For example, the alternating layers overlap in an axial direction of the non-pneumatic tire structure.

For example, each web of the plurality of webs has a straight shape or a curved shape or a double-curved shape.

For example, the branched spoke is X-shaped and comprises an inner link joining the ends of the inner webs and an outer link joining the end of the outer webs; or the branched spoke is Y-shaped and comprises an outer link joining the ends of the outer webs.

For example, the branched spoke is X-shaped and comprises an inner link joining the inner ends of the webs of the plurality of webs which are adjacent to the inner band, and an outer link joining the outer ends of the webs of the plurality of webs which are adjacent to the outer band. Alternatively, the branched spoke is Y-shaped and comprises an outer link joining outer ends of the webs of the plurality of webs which are adjacent to the outer band.

In an embodiment, the spokes have one of a straight shape, a curved shape, a double-curved shape, or any combination thereof, and wherein the bypassed areas filled by the second plastic composition are located at least on the inner band or the outer band or both the inner band and the outer band, so that at least one of the inner band and the outer band has alternating layers of the first plastic composition and the second plastic composition.

For example, at least one selected from the inner band and the outer band comprises the first and the second thermoplastic compositions deposited or arranged so as to exhibit a checkerboard pattern.

In an embodiment, the first plastic composition is formed in situ so that the step of providing a first plastic composition in the form of a filament comprises:
providing a 3-D printer with a preferably heated nozzle;
providing a continuous fiber;
providing a first thermoplastic resin; and
coating the continuous fiber with the first thermoplastic material in the preferably heated nozzle of the 3-D printer to produce a first plastic composition in the form of a filament comprising the continuous fiber coated with the first thermoplastic resin.

According to a fourth aspect, the invention is directed to a non-pneumatic tire structure comprising an inner band, an outer band surrounding the inner band and a spoke part comprising a plurality of spokes extending between the inner band and the outer band, wherein at least one spoke comprises a continuous reinforcement fiber embedded in a first thermoplastic resin that extends from said spoke to one or more selected from the inner band, the outer band, one or more other spokes, or any combination thereof.

For example, the non-pneumatic tire structure is a spoked ring.

In an embodiment, the spokes have a straight shape, a curved shape, a double-curved shape, or any combination thereof. At least one of the inner band or the outer band has alternating layers of the first plastic composition and the second plastic composition. For example, at least one of the inner band or the outer band has a checkerboard pattern made of the first plastic composition and the second plastic composition.

In an embodiment, the direction is perpendicular to the radial direction, or with a fixed angle, or with varying angles with respect to the radial direction, and/or with a fixed angle, or with varying angles with respect to the axial direction.

In an embodiment, the spokes have a branched shape. Said branched shape has a knot section and a plurality of webs, at least one web of the plurality of webs extending from said knot section towards the inner band, and at least two webs of the plurality of webs extending from said knot section towards the outer band. At least one web of the plurality of webs has alternating layers of the first plastic composition and the second plastic composition.

For example, the alternating layers overlap in the axial direction of the non-pneumatic tire structure.

For example, each web of the plurality of webs has a straight shape or a curved shape or a double-curved shape.

For example, the non-pneumatic tire structure is produced by 3D-printing according to the process described in the first or the third aspect.

According to a fifth aspect, the invention comprises a branched spoke of a non-pneumatic tire structure, wherein the spoke is intended to be placed between the inner band and the outer band, and wherein the spoke has a branched shape, said branched shape having a knot section and a plurality of webs. At least one web of the plurality of webs extends from said knot section towards the inner band, and at least two webs of the plurality of webs extend from said knot section towards the outer band. At least one web of the plurality of webs has alternating layers of the first plastic composition and the second plastic composition.

For example, the branched spoke is X-shaped and comprises an inner link joining the ends of the inner webs and an outer link joining the end of the outer webs. Alternatively, the branched spoke is Y-shaped and comprises an outer link joining the ends of the outer webs.

For example, the branched spoke is produced by 3D printing according to the process described in the first, the second or the third aspect.

The following can be used to further define the non-pneumatic tire structure or the branched spoke.

For example, the first thermoplastic resin of the first plastic composition and/or the second thermoplastic resin of the second plastic composition comprises a polymer selected from the group comprising polyoxymethylene, acrylonitrile butadiene styrene, polyamide, polyether ether ketone, cellulose acetate, cellulose acetate propionate, polylactic acid, polyethylene terephthalate, polyethylene terephthalate glycol, polymethylmethacrylate, polypropylene, polystyrene, polyvinyl chloride, polychloroethene, polyester resin, polycarbonate, thermoplastic polyurethane, polyether sulfone, poly(vinyl alcohol), polyphenyl sulfone, polyetherimide, polyethylene, or combinations thereof.

For example, the first thermoplastic resin and the second thermoplastic resin are the same.

In an embodiment, the continuous fiber of the first plastic composition is selected from one or more glass fibers, one or more metallic fibers, one or more carbon fibers, one or more thermoplastic polymers fibers having a melting point above 300° C. according to ISO 3146:2000, or combinations thereof, wherein the one or more thermoplastic polymers fibers having a melting point above 300° C. according to ISO 3146:2000, if any, have a melting point according to ISO 3146:2000 that is higher than the melting point of the first thermoplastic resin by at least 20° C.

For example, the continuous fiber of the first plastic composition is selected from one or more glass fibers, one or more metallic fibers, one or more carbon fibers, one or more polyetherimide fibers, one more polyether ether ketone fibers, or combinations thereof.

For example, the continuous fiber of the first plastic composition is selected from one or more cords, one or more yarns, one or more single filaments, or combinations thereof.

In an embodiment, the inner band and the outer band are essentially concentric to each other.

In another embodiment, the outer band circumferentially surrounds the inner band, in particular radially spaced apart.

In another embodiment, each of the inner band and the outer band are closed and/or have each a ring shape or tube shape.

In another embodiment, the inner band and the outer band are concentrically arranged about the axis of the tire or the axial direction.

In another embodiment, the plurality of spokes is circumferentially arranged about the inner band so as to (resiliently) connect the (radially) inner band to the (radially) outer band.

In another aspect, the present invention is directed to a non-pneumatic tire, such as a passenger car tire or truck tire. The tire may have the features and/or may be made in accordance with the aforementioned aspects.

### Definitions

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” also include the term “consisting of”.

The recitation of numerical ranges by endpoints includes all integer numbers and, where appropriate, fractions subsumed within that range (e.g., 1 to 5 includes 1, 2, 3, 4 and 5 when referring to, for example, a number of elements, and can also include 1.5, 2, 2.75 and 3.80, when referring to, for example, measurements). The recitation of endpoints also includes the recited endpoint values themselves (e.g., from 1.0 to 5.0 includes both 1.0 and 5.0). Any numerical range recited herein is intended to include all sub-ranges subsumed therein.

The reference throughout this specification to “one embodiment” or “an embodiment” means that a particular feature, structure or characteristic described in connection with the embodiment is included in at least one embodiment of the present disclosure. The particular features, structures, characteristics or embodiments may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure and form different embodiments, as would be understood by those in the art.

Unless otherwise defined, all terms used in the disclosure, including technical and scientific terms, have the meaning as commonly understood by one skilled in the art to which this disclosure belongs. By means of further guidance, definitions for the terms used in the description are included to better appreciate the teaching of the present disclosure.

“Axial” means lines or directions that are parallel to the axis of rotation of the tire.

In the disclosure, “3D printing” and “three-dimensional printing” are used as synonymous. In the same way, “3D printer” and “three-dimensional printer” are used as synonymous.

In the disclosure “yarn” and “filament” are used as synonymous.

### BRIEF DESCRIPTION OF THE DRAWINGS

The invention will be described by way of example and with reference to the accompanying drawings in which:

FIG. 1 represents a composite structure of a non-pneumatic tire;

FIG. 2 is a partial perspective view of a non-pneumatique tire according to an embodiment of the invention;

FIG. 3 are two views of a non-pneumatique tire according to the embodiments of the invention with branched spokes;

FIG. 4 is a representation of an X-shaped spoke according to an embodiment of the invention;

FIG. 5 is a representation of a Y-shaped spoke according to another embodiment of the invention;

FIG. 6a and FIG. 6b illustrate a U-shaped layout to print a spoke part wherein the spokes are straight;

FIG. 7 illustrates a crossing layout to print a spoke part, wherein the spokes have a branched shape, such as an X-shape;

FIG. 8 illustrates alternating portions of the first and second plastic compositions between the different layers;

FIG. 9 illustrates a spoked ring comprising an inner band, an outer band surrounding the inner band and a spoke part comprising a plurality of spokes extending between the inner band and the outer band wherein the spokes are X-shaped; and

FIG. 10 illustrates the results of the dynamic crush tests.

### DETAILED DESCRIPTION OF THE INVENTION

The following is an explanation of a process according to an embodiment of the invention for the production of at least a part of a non-pneumatic tire structure or the whole non-pneumatic tire structure. The non-pneumatic tire structure comprises at least a hub, a shear band and a spoke section comprising a plurality of spokes. With preference, the process for the production of at least a part of a non-pneumatic tire structure comprises the production of one or more spokes. In an embodiment, the spokes are linked or integral with an inner band and/or an outer band surrounding the inner band, wherein the plurality of spokes extends between the inner and the outer band. The inner band can be the hub of the non-pneumatic tire structure or can be different from said hub. Similarly, the outer band can be the shear band of the non-pneumatic tire structure or can be different from the said shear band. The present invention is also related to spokes, to parts of non-pneumatic tire structures, and to non-pneumatic tire structures produced according to said process. The non-pneumatic tire structures of the invention can be integrally produced by said process or can be partially produced by such a process. This can be the case when the non-pneumatic tire structure comprises different parts assembled together.

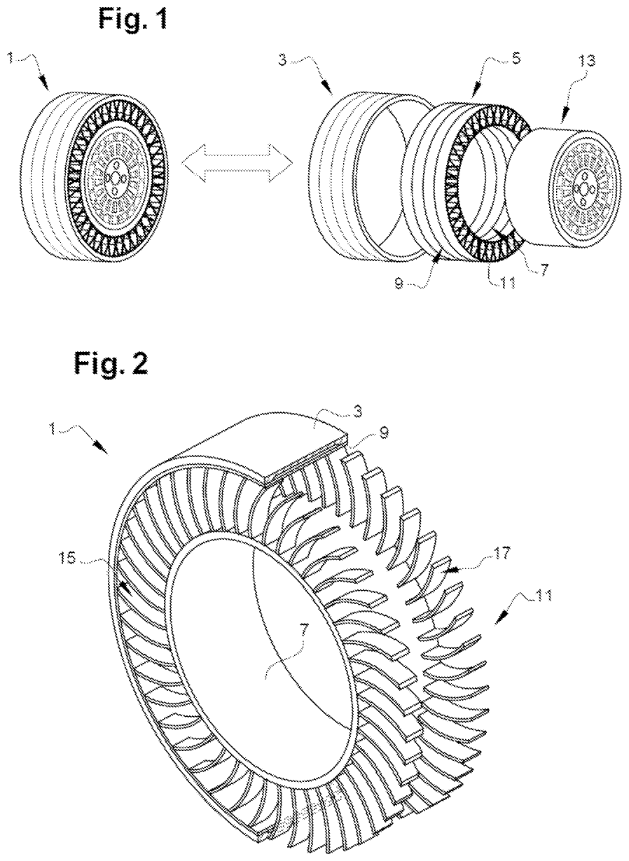

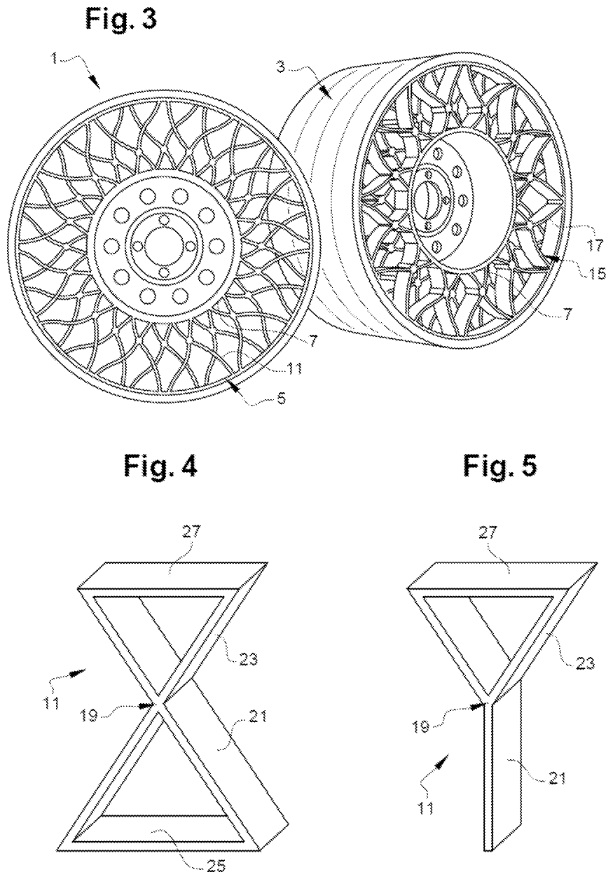

Reference is now made to FIG. 1 which illustrates a non-pneumatic tire. Typically, a non-pneumatic tire 1 is or comprises a composite structure comprising a shear band 3, a connecting spoke part 5 and a rim 13. In FIG. 1, the connecting spoke part comprises an inner band 7, an outer band 9 and a plurality of spokes 11 extending between the inner band 7 and the outer band 9. For example, the connecting spoke part 5 is a monobloc. The inner band 7 is wrapped in the outer band 9. FIGS. 2 and 3 illustrate examples of non-pneumatic tire structures. In FIG. 2, the plurality of spokes 11 are arranged in two annular rows (a first row 15 and a second row 17) succeeding one another in the axial direction and that extend between the inner band 7 and the outer band 9. The spokes on each row are curved. The shear band 3 is placed on the outer band 9. The rim is not illustrated but would be surrounded by the inner band 7. In FIG. 3, the plurality of spokes 11 are arranged in two rows (a first row 15 and a second row 17) succeeding one another in the axial direction and that extend between the inner band 7 and the outer band 9. The spokes 11 have a branched shape, in particular, in this example, an X-shape. These two figures are given for an illustrative purpose and do not intend to limit the invention.

FIGS. 4 and 5 illustrate spokes 11 with a branched shape. According to the invention, said branched shape has a knot section 19 and a plurality of webs 21, 23, wherein at least one web 21 of the plurality of webs is intended to extend from said knot section towards the inner band (also named the inner webs 21 hereinafter), and at least two webs 23 of the plurality of webs are intended to extend from said knot section towards the outer band (also named the outer webs 23 hereinafter). Each web of the plurality of webs can have a straight shape, a curved shape, or a double curved shape. In FIG. 4, the branched spoke 11 is X-shaped and comprises an inner link 25 joining the ends of the inner webs 21 and an outer link 27 joining the ends of the outer webs 23. In FIG. 5, the branched spoke 11 is Y-shaped and comprises an outer link 27 joining the ends of the outer webs 23. The outer links can be integral to the outer band or different from the outer band. Similarly, the inner links can be integral to the inner band or different from the inner band.

In an embodiment, the invention is directed to a process for the production of at least a part of a non-pneumatic tire structure, the non-pneumatic tire structure comprising an inner band, an outer band surrounding the inner band and a spoke part comprising a plurality of spokes extending between the inner band and the outer band, wherein the process comprises steps of:
providing a first plastic composition in the form of a filament comprising a continuous fiber coated with a first thermoplastic resin; and
forming one or more selected from one or more spokes, the inner band and the outer band of the non-pneumatic tire structure by 3D printing including depositing layers from the first plastic composition.

The first plastic composition is a continuous fiber reinforced composite that is provided in the form of a filament wherein a continuous reinforcement fiber is embedded in a thermoplastic resin.

3D printing with continuous fibers as such is a technique known to the person skilled in the art and is not described herein in detail. For example, 3D-printing with continuous carbon fibers is reported in van der Klift, F., Koga, Y., Todoroki, A., Ueda, M., Hirano, Y. and Matsuzaki, R. (2016) in “3D Printing of Continuous Carbon Fiber Reinforced Thermo-Plastic (CFRTP) Tensile Test Specimens”, Open Journal of Composite Materials, 6, 18-27, which is incorporated herein by reference.

Filament-based 3D printers, such as FFF printers, are known to the person skilled in the art and are commercially available. FFF printers comprise an extruder and a hotend. The extruder is driving the thermoplastic filament through the 3D printing system and is responsible for controlling the material feed into the hotend. The extruder typically comprises a stepper motor that activates gears, which in turn grip the filament and push it through the hotend and onto the print bed. The hotend is the component of a 3D printer that melts the filament for extrusion and helps to maintain a consistent and accurate temperature for successful prints. The hotend is responsible for melting and depositing material. The hotend typically comprises a guiding tube for the filament, a heating element, and a brass nozzle. The extruder will drive the filament through the hotend where it will be heated until molten and then further extruded through the nozzle and onto the print bed. Once heated, the nozzle also serves to decrease the filament diameter from the initial 1.75 or 3.00 mm to a diameter that may range from 0.2 to 0.4 mm, depending on the nozzle. For example, the initial filament diameter is 1.75 mm. When the filament is a continuous fiber reinforced composite, the continuous reinforcement fibers can be provided as such or produced in-situ in the nozzle of the 3D-printer.

Methods for production of such continuous fiber reinforced composites are known to the person skilled in the art and are not described herein in detail. For example, the continuous fiber reinforced composite can be produced by in-situ impregnation or in-nozzle impregnation. Such a process is described in Matsuzaki, R., Ueda, M., Namiki, M. et al. in “Three-dimensional printing of continuous-fiber composites by in-nozzle impregnation”, Sci Rep 6, 23058 (2016) and in WO2020197707 which are incorporated herein by reference. In the in-nozzle or in-situ impregnation, a thermoplastic filament and a continuous fiber are separately supplied to the 3D printer and the fiber is impregnated with the thermoplastic material within the heated nozzle of the printer immediately before printing.

More than one reinforcing single-filament can be included during the manufacturing of the 3D-printing composite-filament, with the single filaments being geometrically separated. The section of the composite filament can have a circular, an oval, or a multi-angles section.

For example, the process further comprises the steps of producing the first thermoplastic composition. In such a case, the step of providing a first plastic composition in the form of a filament comprises:
providing a 3-D printer, optionally with a heated nozzle;
providing a continuous fiber;
providing a first thermoplastic resin; and
coating the continuous fiber with the first thermoplastic material in the optionally heated nozzle of the 3-D printer to produce a first plastic composition in the form of a filament comprising a continuous fiber coated with a first thermoplastic resin, and providing such a first plastic composition.

The process for the production of at least a part of a non-pneumatic tire structure, the non-pneumatic tire structure comprising an inner band, an outer band surrounding the inner band and a spoke part comprising a plurality of spokes extending between the inner band and the outer band can also comprise the steps of:
providing a 3-D printer with an optionally heated nozzle;
providing a continuous fiber;
providing a first thermoplastic resin;
coating the continuous fiber with the first thermoplastic material in the optionally heated nozzle of the 3-D printer to produce a first plastic composition in the form of a filament comprising continuous fiber coated with a first thermoplastic resin, and providing such a first plastic composition; and
forming one or more selected from i) one or more spokes, ii) the inner band and iii) the outer band of the non-pneumatic tire structure by 3D printing, wherein forming includes depositing layers from the first plastic composition, and providing such a first plastic composition.

In particular, the continuous fiber is a reinforcement fiber. A preferred feature of the invention is that the same continuous fiber may extend from at least one spoke to the inner band, or from at least one spoke to the outer band, or from at least one spoke to both the inner band and the outer band, or from at least one spoke to one or more other spokes. Since the continuous fiber is deposited through layers of the first plastic composition, according to an embodiment of the invention, one or more layers of the first plastic composition extend from at least one spoke to the inner band, or from at least one spoke to the outer band, or from at least one spoke to both the inner band and the outer band, or from one spoke to one or more other spokes.

It is understood that the spokes can be produced individually from the first plastic composition or both the first plastic composition and at least one second plastic composition. However, the invention also encompasses the production of two or more spokes wherein the spokes are printed together so that the one or more continuous reinforcement fibers extend from one spoke to one or more other spokes without being interrupted. The continuous fiber, preferably a single continuous fiber, optionally spans the spokes, the inner band and the outer band. Also, the invention encompasses the production of the whole spoke part with the same continuous fibers so that the same continuous fibers extend from the inner band, the outer band and the plurality of spokes without being interrupted.

The continuous fibers can be of any type. Preferably, the continuous fiber of the first plastic composition is selected from one or more cords, one or more yarns, one or more single filaments or combinations thereof. For example, the continuous fiber is a single filament, or several geometrically separated filaments, or a single yarn or a single cord.

In an embodiment, the continuous fiber of the first plastic composition is selected from one or more glass fibers, one or more metallic fibers, one or more carbon fibers, one or more thermoplastic polymers fibers having a melting point above 300° C. according to ISO 3146:2000, or combinations thereof. With preference, the one or more thermoplastic polymers fibers having a melting point above 300° C. according to ISO 3146:2000, if any, have a melting point according to ISO 3146:2000 that is higher than the melting point of the first thermoplastic resin by at least 20° C.

In an embodiment, the continuous fiber of the first plastic composition is selected from one or more glass fibers, one or more metallic fibers, one or more carbon fibers, one or more polyetherimide fibers, one or more polyether ether ketone fibers, or combinations thereof.

In an embodiment, the continuous fiber of the first plastic composition is selected from one or more glass fibers, one or more metal fibers, one or more carbon fibers, or combinations thereof.

For example, the one or more metal fibers are selected from metal cords, metal wires and metal strands. For example, the one or more metal fibers are steel wires or steel cords. According to an embodiment, the continuous fiber is or comprises a steel wire having a diameter ranging from 140 to 400 μm, preferably from 150 to 200 μm.

For example, the one or more glass fibers are or comprise glass yarn. An example of commercially available glass yarn suitable to be used in the invention is EC 9-136 S 28 B3/4J or EC 9-136 Z 28 B3/4J, both with a diameter of 9 μm as determined according to ISO 1888.

According to an embodiment, the continuous fiber is or comprises a glass yarn having a diameter ranging from 5 to 20 μm, preferably from 5 to 10 μm as determined according to ISO 1888.

According to an embodiment, the continuous fiber is or comprises continuous carbon fibers yarn having a diameter ranging from 5 to 10 μm. Thus, in an embodiment of the invention, the continuous fiber has a diameter ranging from 5 to 10 μm and is selected from a carbon fiber or a glass yarn.

According to an embodiment of the invention, the one or more thermoplastic fibers are made of a polymer that is different from the first thermoplastic resin and that has a melting point above 300° C. according to ISO 3146:2000, wherein the polymer is selected from one or more of polyetherimide, polyether ether ketone, or combinations thereof.

For example, the one or more thermoplastic fibers made of a polymer having a melting point above 300° C. according to ISO 3146:2000 are or comprise one or more polyether ether ketones. The polyether ether ketone (PEEK) has a melting point of about 343° C. The melting point is determined according to ISO 3146:2000.

For example, the one or more thermoplastic fibers made of a polymer having a melting point above 300° C. according to ISO 3146:2000 are or comprise one or more polyetherimides (CAS 61128-46-9). The polyetherimide (PEI) has a melting point ranging from 340 to 360° C. The melting point is determined according to ISO 3146:2000. Non-limiting examples of suitable PEI filaments that can be used in the context of the disclosure are commercially available under the denomination of ULTEM™ FILAMENT.

It is understood that, when used as reinforcing material, the one or more thermoplastic fibers made of a polymer having a melting point above 300° C. according to ISO 3146:2000 do not melt during the 3D-printing step.

Thus, the first thermoplastic resin and the polymer having a melting point above 300° C. are different and have different melting points according to ISO 3146:2000 by at least 20° C., preferably at least 30° C., more preferably at least 40° C., even more preferably at least 50° C. and most preferably at least 60° C., or at least 70° C. In all cases, the polymer used in the one or more thermoplastic fibers has a melting point higher than the melting point of the first thermoplastic resin.

For example, the continuous fiber can be polyether ether ketone and the first thermoplastic resin can be thermoplastic polyurethane. In such a case the difference between the respective melting points is more than 50° C.

The first thermoplastic resin of the first plastic composition can be any thermoplastic resin suitable for 3D printing, with the provision that it is different from the polymer used in the one or more thermoplastic fibers if applicable (so that they have different melting points). For example, the first thermoplastic resin of the first plastic composition comprises a polymer selected from the group of polyoxymethylene, acrylonitrile butadiene styrene, polyamide, polyether ether ketone, cellulose acetate, cellulose acetate propionate, polylactic acid, polyethylene terephthalate, polyethylene terephthalate glycol, polymethylmethacrylate, polypropylene, polystyrene, polyvinyl chloride, polychloroethene, polyester resin, polycarbonate, thermoplastic polyurethane, polyether sulfone, poly(vinyl alcohol), polyphenyl sulfone, polyether imide, polyethylene, or combinations thereof.

In an embodiment, the first thermoplastic resin is selected from polyether ether ketone, polysulfone, polyether sulfone, polyether imide, polyamide, polybutylene terephthalate, polyethylene, polycarbonate, thermoplastic polyurethane, or combinations thereof. For example, the first thermoplastic resin is or comprises one of polyamide, thermoplastic polyurethane, or combinations thereof. For example, the first thermoplastic resin is or comprises one or more polyamides selected from Nylon-6, Nylon-6,6, Nylon-6,9, Nylon-6,10, Nylon-6,12, Nylon-11, Nylon-4,6 and Nylon-66/6 copolymer.

Non-limiting examples of suitable nylon filaments that can be used in the context of the disclosure are commercially available under the denomination PolyMide™ CoPA. Non-limiting examples of suitable polyether imide filaments that can be used in the context of the disclosure are commercially available under the denomination of ULTEM™ FILAMENT. A non-limiting example of a material suitable for thermoplastic polyurethane filaments that can be used in the context of the disclosure is for instance polyether based TPU commercially available under the denomination of Elastollan® 1195A.

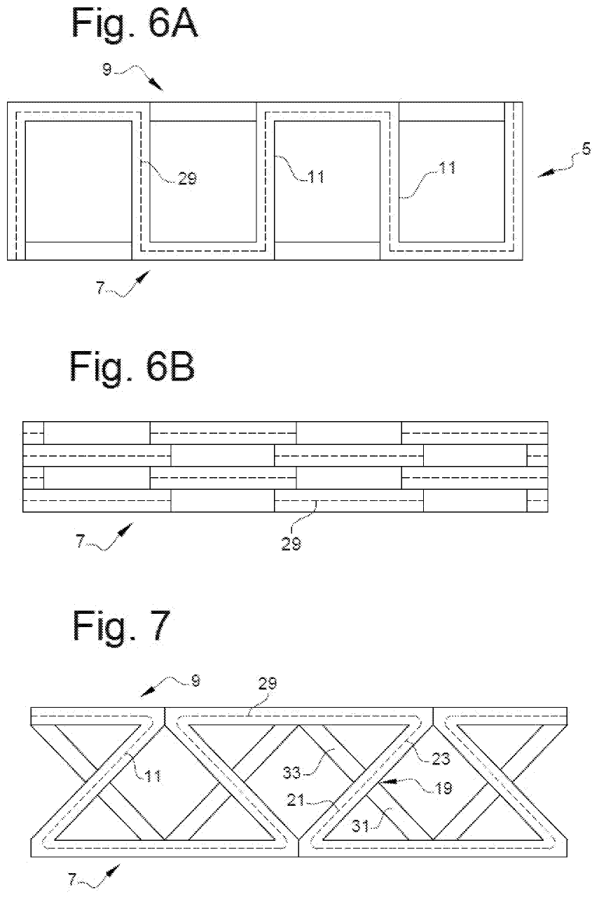

In embodiments in which the one or more layers of the first plastic composition extend from at least one spoke to the inner band, or from at least one spoke to the outer band, or from at least one spoke to both the inner band and the outer band, or from one spoke to one or more other spokes, and in embodiments in which the at least one spoke of said plurality of spokes has a branched shape, the continuous fiber is preferably not interrupted. As a consequence, in a specific layer, the first plastic composition comprising the continuous fiber cannot necessarily pass everywhere without generating occasional extra thicknesses. In such a specific layer, where the bypassed areas are not covered by the deposit of the first plastic composition, those can be supplemented by a deposit of a second plastic composition on an intermittent print mode as illustrated in FIGS. 6 and 7.

In such a configuration, the production process further comprises the steps of:
providing a second plastic composition selected from an unreinforced plastic, a short-fibers reinforced thermoplastic resin, a long-fibers reinforced thermoplastic resin, or a fiber reinforced thermoplastic resin, and
forming a plurality of spokes, the inner band and the outer band of the non-pneumatic tire structure by 3D printing, wherein forming includes depositing layers from the first plastic composition and, for each layer, completing the layer of the first plastic composition by depositing the second plastic composition in the bypassed areas where the first composition has not been deposited.

FIGS. 6a and 6b illustrate a U-shaped layout to print a spoke part. In FIG. 6a, the spokes 11 are straight but could be curved or double-curved. The spoke-direction can be perpendicular to the radial direction, or with a fixed angle, or with varying angles, with respect to the radial direction. The spoke-direction can also have a fixed, or varying angle with the axial direction. It is understood that, in such a U-shaped layout configuration, at least two spokes are printed together using a single continuous filament 29 (shown in dotted lines) of the first plastic composition to be integral. The spokes 11 are produced by successive layers stacked in the axial direction. FIG. 6b is a view of the inner band 7. The layers comprise different layer portions, namely first layer portions and second layer portions. The successive layers are made of the first plastic composition that comprises the continuous fiber 29. The first plastic composition forms the first layer portion. The inner band and the outer band comprise along their circumferential direction alternated portions made of the first plastic composition (comprising the continuous reinforcement fiber) and the second plastic composition. The second plastic composition forms the second layer portion. The second layer portion fills the bypassed areas. So, the first plastic composition extends from at least one spoke to the inner band and the outer band. In the axial direction, a similar alternated pattern is visible with the alternation of layers of the first and second plastic composition. The alternated pattern of the first and second plastic composition in both the circumferential and axial direction provides a checkerboard pattern to the inner band and/or to the outer band. Thus, the pattern can be considered as a checkerboard pattern. It exhibits a first meshing formed by the first plastic composition and a second meshing formed by the second plastic composition, said first and second meshings being interlocked in one another.

For example, the orientation of the spokes in the U-shaped layout versus the radial direction can be perpendicular, or in an fixed angle, or with varying angles; and/or the orientation of the spokes in the U-shaped layout can be in a fixed, or varying, angle(s) with the axial direction.

Thus, in an embodiment in which the spokes have a straight shape, a curved shape, a double-curved shape, or any combination thereof, the bypassed areas completed by the second plastic composition are located at least on the inner band or the outer band or both the inner band and the outer band, so that at least one of the inner band and the outer band have alternated layers of the first plastic composition and the second plastic composition. With preference, at least one selected from the inner band and the outer band comprises the first and the second thermoplastic compositions deposited to show a checkerboard pattern.

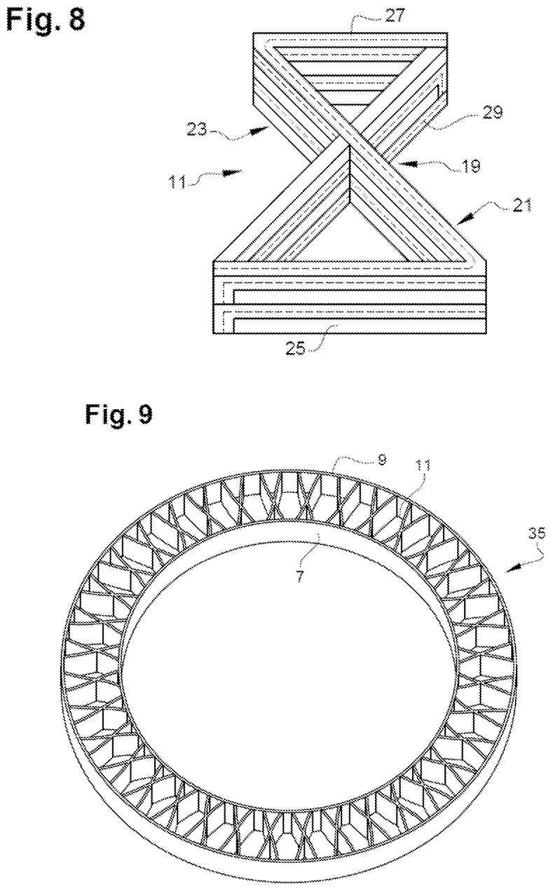

FIG. 7 illustrates a crossing layout wherein the spokes have a branched shape, such as an X-shape. In such a configuration, the inner band and the outer band may be produced by successive layers, in the axial direction, of the first plastic composition. Each spoke comprises a knot section 19 and a plurality of webs 21, 23, in this case, two inner webs 21 and two outer webs 23. In a specific layer, one of the inner webs and one of the outer webs are integral and made from the first plastic composition, whereas the other inner web 31 and the other outer web 33 are made from the second plastic composition. As a consequence, and as illustrated in FIG. 8 in connection with a single spoke, the webs have alternating layers of the first plastic composition and of the second plastic composition.

Thus, in an embodiment, the spokes have a branched shape, wherein said branched shape has a knot section and a plurality of webs. At least one web of the plurality of webs extends from said knot section towards the inner band and at least two webs of the plurality of webs extend from said knot section towards the outer band. The areas completed by the second plastic composition are located at least on one web so that at least one web of the plurality of webs has alternating layers of the first plastic composition and the second plastic composition. For example, the process further comprises interrupting the deposit of the second plastic composition at the knot section so that the knot section is formed from layers of the first plastic composition only. For example, in the one or more webs comprising alternated layers, the alternated layers overlap in the axial direction of the non-pneumatic tire structure. For example, each web of the plurality of webs has a straight shape or a curved shape or a double-curved shape.

The second plastic composition comprises a second thermoplastic resin and is preferably selected from an unreinforced thermoplastic resin, a short-fibers reinforced thermoplastic resin, a long-fibers reinforced thermoplastic resin, or a fiber reinforced thermoplastic resin.

In an embodiment, the second thermoplastic resin of the second plastic composition can be any thermoplastic resin suitable for 3D printing. For example, the second thermoplastic resin of the first plastic composition comprises a polymer selected from the group comprising polyoxymethylene, acrylonitrile butadiene styrene, polyamide, polyether ether ketone, cellulose acetate, cellulose acetate propionate, polylactic acid, polyethylene terephthalate, polyethylene terephthalate glycol, polymethylmethacrylate, polypropylene, polystyrene, polyvinyl chloride, polychloroethene, polyester resin, polycarbonate, thermoplastic polyurethane, polyether sulfone, poly(vinyl alcohol), polyphenyl sulfone, polyether imide, polyethylene, or combinations thereof.

In a preferred embodiment, the first and the second thermoplastic resins are the same or at least of the same nature or type.

In an embodiment, the short fibers and/or the long-fibers are selected from carbon fibers, glass fibers, or any combination thereof. With preference, short fibers and/or the long-fibers are carbon fibers. Non-limiting examples of suitable reinforced PEEK filaments that can be used in the context of the disclosure are commercially available under the denomination of CarbonX™ CF-PEEK.

The invention also encompasses the individual production of branched spokes in the same way. For example, the invention further provides a process for the production of a branched spoke of a non-pneumatic tire structure, wherein the spoke is intended to be placed between the inner band and the outer band, wherein the spoke has a branched shape, said branched shape having a knot section and a plurality of webs, wherein at least one web of the plurality of webs extends from said knot section towards the inner band, and at least two webs of the plurality of webs extend from said knot section towards the outer band. The process comprises the steps of:
providing a first plastic composition in the form of a filament comprising a continuous fiber coated with a first thermoplastic resin,
providing a second plastic composition selected from an unreinforced plastic, a short-fibers reinforced thermoplastic resin, a long-fibers reinforced thermoplastic resin or a fiber reinforced thermoplastic resin, and
forming the spoke of the non-pneumatic tire structure by 3D printing including depositing layers from the plastic compositions wherein forming includes depositing layers from the first plastic composition and wherein depositing comprises defining bypassed areas which are bypassed by the first plastic composition deposition, for each layer, filling the layer of the first plastic composition by depositing the second plastic composition in the bypassed areas where the first composition has not been deposited, and wherein the bypassed areas completed by the second plastic composition are located at least on one web so that at least one web of the plurality of webs has alternating layers of the first plastic composition and of the second plastic composition.

The different features described for the process for production of at least a part of a non-pneumatic tire structure may apply to the process of production of the spokes. The different features described for the process for production of at least a part of a non-pneumatic tire structure may apply to the process of production of a spoked ring as illustrated in FIG. 9. The spoked ring 35 comprises an inner band, an outer band surrounding the inner band and a spoke part comprising a plurality of spokes extending between the inner band and the outer band. In FIG. 9, the spokes are X-shaped, but the spoked ring may comprise spokes of another shape. Also the disclosure further encompasses parts of the spoked ring.

For example, the branched spoke is X-shaped and comprises an inner link joining the ends of the inner webs and an outer link joining the ends of the outer webs, or the branched spoke is Y-shaped and comprises an outer link joining the ends of the outer webs.

For example, the thermoplastic resin of the first plastic composition and of the second plastic composition comprises the same polymer, wherein the polymer is selected from the group comprising polyoxymethylene, acrylonitrile butadiene styrene, polyamide, polyether ether ketone, cellulose acetate, cellulose acetate propionate, polylactic acid, polyethylene terephthalate, polyethylene terephthalate glycol, polymethylmethacrylate, polypropylene, polystyrene, polyvinyl chloride, polychloroethene, polyester resin, polycarbonate, thermoplastic polyurethane, polyether sulfone, poly(vinyl alcohol), polyphenyl sulfone, polyetherimide, polyethylene, or combinations thereof.

For example, the second plastic composition is an unreinforced plastic and both the first and the second thermoplastic resins are the same and are selected from polyether ether ketone, polysulfone, polyether sulfone, polyether imide, polyamide, polybutylene terephthalate, polyethylene, polycarbonate, thermoplastic polyurethane, or combinations thereof. In addition, the continuous fiber is selected from a glass yarn or a carbon fiber.

### Examples

X-shaped spokes have been produced by 3D printing according to an embodiment of the process of the invention. The first and second thermoplastic resins were a polyether-based TPU commercially available under the denomination of Elastollan® 1195A. The continuous fiber was the glass yarn EC 9-136 S 28 B3/4J which had a 9 μm diameter.

The X-shaped spokes comprised an inner link joining the ends of the inner webs and an outer link joining the end of the outer webs.

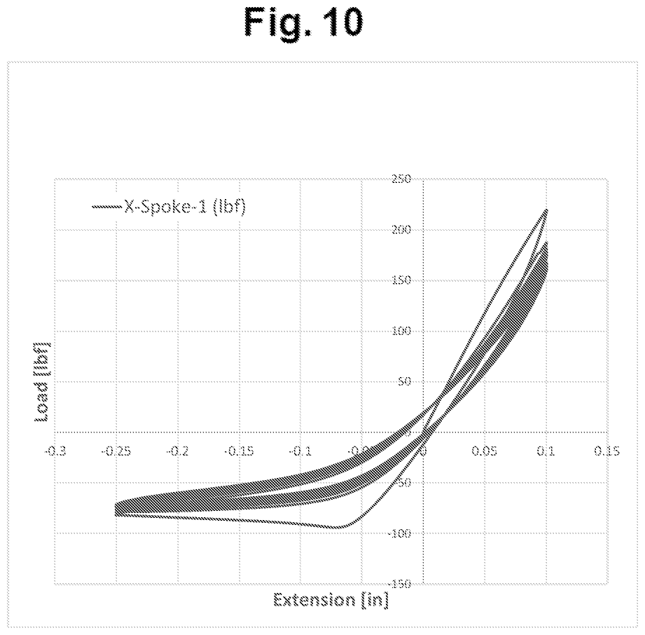

Dynamic crush tests have been performed for which results have been provided in FIG. 10.

For the Dynamic Crush Test, the X-spoke sample was fixed between a piston (bottom) and a load-cell (top), wherein the load cell was geometrically fixed.

The piston was displaced in a vertical direction with a defined displacement range during a defined time per cycle (42.12 s/cycle), and the resulting force-changes were measured by the load cell.

Fifteen such cycles have been performed with a relative velocity of 0.0166 inch/second (˜0.42 mm/s), for a total displacement of 0.70 inch (˜17.8 mm) per cycle.

Under these parameters, after a first break-in cycle, a relatively elastic response of the 3D-printed continuous-fiber-reinforced X-spoke sample could be demonstrated.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A process for the production of at least a part of a non-pneumatic tire structure, the non-pneumatic tire structure comprising an inner band, an outer band surrounding the inner band and a spoke part comprising a plurality of spokes extending between the inner band and the outer band, wherein the process comprises
providing a first plastic composition in the form of a filament comprising a continuous fiber coated with a first thermoplastic resin; and
forming one or more selected from at least one spoke of the plurality of spokes, the inner band and the outer band of the non-pneumatic tire structure by 3D printing, wherein forming includes depositing layers of the first plastic composition.

2. The process of claim 1 wherein one or more layers of the first plastic composition extend from at least one spoke of the plurality of spokes to the inner band or the outer band, or from the inner band to at least one spoke of the plurality of spokes or from the outer band to at least one spoke of the plurality of spokes, or within two different spokes of the plurality of spokes.

3. The process of claim 1 wherein the first thermoplastic resin of the first plastic composition comprises a polymer selected from the group comprising polyoxymethylene, acrylonitrile butadiene styrene, polyamide, polyether ether ketone, cellulose acetate, cellulose acetate propionate, polylactic acid, polyethylene terephthalate, polyethylene terephthalate glycol, polymethylmethacrylate, polypropylene, polystyrene, polyvinyl chloride, polychloroethene, polyester resin, polycarbonate, thermoplastic polyurethane, polyether sulfone, poly(vinyl alcohol), polyphenyl sulfone, polyetherimide, polyethylene, or combinations thereof.

4. The process of claim 1 wherein the continuous fiber of the first plastic composition is selected from one or more glass fibers, one or more metallic fibers, one or more carbon fibers, one or more thermoplastic polymers fibers having a melting point above 300° C. according to ISO 3146:2000, or combinations thereof; wherein the one or more thermoplastic polymers fibers having a melting point above 300° C. according to ISO 3146:2000, if any, have a melting point according to ISO 3146:2000 that is higher than the melting point of the first thermoplastic resin by at least 20° C.

5. The process of claim 1 wherein the continuous fiber of the first plastic composition is selected from one or more cords, one or more yarns, one or more single filaments, or combinations thereof.

6. The process of claim 1, wherein the first thermoplastic resin of the first plastic composition is or comprises polyamide, thermoplastic polyurethane, or combinations thereof; and wherein the continuous fiber of the first plastic composition has a diameter ranging from 5 to 10 μm and is selected from a carbon fiber or a glass yarn.

7. The process of claim 1, wherein forming a plurality of spokes comprises defining a bypassed area in the layer of the first plastic composition, the process further comprising
providing a second plastic composition selected from an unreinforced plastic, a short-fibers reinforced thermoplastic resin, or a long-fibers reinforced thermoplastic resin, and
filling the bypassed area by depositing the second plastic composition in said bypassed area.

8. The process of claim 7, wherein one or more spokes of the plurality of spokes have a branched shape; said branched shape has a knot section and a plurality of webs, the plurality of webs comprising at least one inner web extending from said knot section towards the inner band, and at least two outer webs extending from said knot section towards the outer band; and wherein the areas bypassed by the first plastic composition and filled by the second plastic composition are located at least on one web so that at least one web of the plurality of webs has alternating layers of the first plastic composition and the second plastic composition.

9. The process of claim 8, wherein the process further comprises interrupting the deposit of the second plastic composition at the knot section so that the knot section is formed from layers of the first plastic composition which are touching one another.

10. The process of claim 8 wherein the alternating layers overlap in an axial direction of the non-pneumatic tire structure or wherein each web of the plurality of webs has one of a straight shape, a curved shape, and a double-curved shape.

11. The process of claim 7, wherein the spokes have a straight shape, a curved shape, or a double-curved shape, or any combination thereof; and wherein the bypassed areas filled by the second plastic composition are located at least on the inner band or the outer band, or both the inner band and the outer band, so that at least one of the inner band or the outer band has alternating layers of the first plastic composition and the second plastic composition.

12. The process of claim 11 wherein at least one selected from the inner band and the outer band comprises the first and the second thermoplastic compositions deposited so as to exhibit a checkerboard pattern.

13. The process of claim 1 wherein the first plastic composition is formed in situ so that the step of providing a first plastic composition in the form of a filament comprises:
providing a 3-D printer with a heated nozzle;
providing a continuous fiber;
providing a first thermoplastic resin; and
coating the continuous fiber with the first thermoplastic material in the heated nozzle of the 3-D printer to produce a first plastic composition in the form of a filament comprising the continuous fiber coated with the first thermoplastic resin.

14. A process for the production of a branched spoke of a non-pneumatic tire structure, wherein the branched spoke is intended to be placed between an inner band and an outer band, and wherein the branched spoke has a branched shape with a knot section and a plurality of webs, at least one web of the plurality of webs extending from said knot section towards the inner band, and at least two webs of the plurality of webs extending from said knot section towards the outer band; wherein the process comprises:
providing a first plastic composition in the form of a filament comprising a continuous fiber coated with a first thermoplastic resin,
providing a second plastic composition selected from an unreinforced plastic, or a fiber reinforced thermoplastic resin, and
forming the branched spoke of the non-pneumatic tire structure by 3D printing including depositing layers of the plastic composition wherein forming further includes depositing layers from the first plastic composition defining bypassed areas and, for each layer, filling the bypassed areas by depositing the second plastic composition in the bypassed areas, and wherein the bypassed areas comprising the second plastic composition are located at least on one web so that at least one web of the plurality of webs exhibits alternating layers of the first plastic composition and the second plastic composition.

15. The process of claim 14 further comprising interrupting the layers of the second plastic composition at the knot section so that the knot section is formed from layers of the first plastic composition.

16. The process of claim 14 wherein the thermoplastic resin of the first plastic composition and of the second plastic composition comprises the same polymer, wherein the polymer is selected from the group comprising polyoxymethylene, acrylonitrile butadiene styrene, polyamide, polyether ether ketone, cellulose acetate, cellulose acetate propionate, polylactic acid, polyethylene terephthalate, polyethylene terephthalate glycol, polymethylmethacrylate, polypropylene, polystyrene, polyvinyl chloride, polychloroethene, polyester resin, polycarbonate, thermoplastic polyurethane, polyether sulfone, poly(vinyl alcohol), polyphenyl sulfone, polyetherimide, polyethylene, or combinations thereof.

17. The process of claim 14 wherein
the second plastic composition is an unreinforced plastic;
the first thermoplastic resin and the second thermoplastic resin are the same and are selected from polyether ether ketone, polysulfone, polyether sulfone, polyether imide, polyamide, polybutylene terephthalate, polyethylene, polycarbonate, thermoplastic polyurethane, or combinations thereof; and
the continuous fiber is selected from a glass yarn or a carbon fiber.

18. The process of claim 14 wherein the branched spoke is one of:
i) X-shaped and comprises an inner link joining the inner ends of the webs of the plurality of webs which are adjacent to the inner band, and an outer link joining the outer ends of the webs of the plurality of webs which are adjacent to the outer band;
ii) Y-shaped and comprises an outer link joining outer ends of the webs of the plurality of webs which are adjacent to the outer band.

19. A process for the production of at least a part of a non-pneumatic tire structure, the non-pneumatic tire structure comprising an inner band, an outer band surrounding the inner band and a spoke part comprising a plurality of spokes extending between the inner band and the outer band; wherein the process comprises:
providing a 3-D printer with a heated nozzle;
providing a continuous fiber;
providing a first thermoplastic resin;
coating the continuous fiber with the first thermoplastic material in the heated nozzle of the 3-D printer to produce a first plastic composition in the form of a filament comprising the continuous fiber coated with the first thermoplastic resin; and
forming one or more selected from one or more spokes of the plurality of spokes, the inner band and the outer band of the non-pneumatic tire structure by 3D printing, wherein forming includes depositing layers of the first plastic composition.

20. The process of claim 19 wherein the first thermoplastic resin is selected from polyether ether ketone, polysulfone, polyether sulfone, polyether imide, polyamide, polybutylene terephthalate, polyethylene, polycarbonate, thermoplastic polyurethane, or combinations thereof; and wherein the continuous fiber has a diameter ranging from 5 to 10 μm and is selected from a carbon fiber or a glass yarn.
